(19) United States
(12) Patent Application Publication
(10) Pub. No.: US 2024/0272299 A1
(43) Pub. Date: Aug. 15, 2024

(54) LIDAR LOCALIZATION

(71) Applicant: Luminar Technologies, Inc., Orlando, FL (US)

(72) Inventor: Scott Harvey, San Francisco, CA (US)

(21) Appl. No.: 18/107,663

(22) Filed: Feb. 9, 2023

(51) Int. Cl. G01S 17/89

(52) U.S. Cl. CPC G01S 17/89; G01S 17/86

(57) ABSTRACT

Observed environment lidar sensor data including a plurality of spatial points is received for a mobile entity. The observed environment lidar sensor data is transformed into one or more alternative observed environment candidates. A corresponding observed environment reduced representation is calculated for the observed environment lidar sensor data and each of the one or more alternative observed environment candidates. The observed environment reduced representations is correlated with reference reduced representations for different geographical locations to determine correlation results. Based on the correlation results, a current location of the mobile entity is identified.

### BACKGROUND OF THE INVENTION

A Global navigation satellite system (GNSS), such as a global positioning system (GPS) may be used to identify a location of a mobile entity. The GPS may be inconsistent based on one or more factors, such as the time of day, the position of the satellites, the presence of tall buildings, the environment, etc. As a result, the GPS may provide an inaccurate location of the mobile entity. GPS data may be fused with data associated with one or more other sensors (e.g., inertial measurement unit (IMU), camera, light detection and ranging (LIDAR), wheel encoders, radar, etc.) to reduce the amount of uncertainty associated with the GPS data. However, fusing the data associated with the one or more other sensors with the GPS data may lead to a more fragile system because the uncertainty estimations for each sensor may not be accurate before fusing the results, the calibration between the sensors is inaccurate, and/or the estimation from one sensor is dependent from the other sensors.

### BRIEF DESCRIPTION OF THE DRAWINGS

Various embodiments of the invention are disclosed in the following detailed description and the accompanying drawings.

FIG. 1A is a simplified diagram of a navigation and location architecture for mobile entities according to various embodiments.

FIG. 1B is a simplified digital image of an environmental region that may be generated in part by a mobile entity according to various embodiments.

FIG. 1C is a block diagram of a system for determining locations of mobile entities in accordance with various embodiments.

FIG. 2A is a diagram of a region where a mobile entity is collecting reference data according to various embodiments.

FIG. 2B is a diagram of a region being navigated by a mobile entity according to various embodiments.

FIG. 2C is a diagram a region subdivided into a plurality of sub-regions according to various embodiments.

FIG. 2D is a diagram of a region including a plurality of the sub-regions according to various embodiments.

FIG. 2E is a diagram of a plane of a region 20C including a plurality of the sub-regions in rows and columns according to various embodiments.

FIG. 3 is a flow diagram illustrating an embodiment of a process for identifying a current location of a mobile entity.

FIG. 4A is a block diagram of a mobile system that may be employed in an NLA to provide reference data of an environment and enable a mobile entity to navigate the environment according to various embodiments.

FIG. 4B is a block diagram of another mobile system that may be employed in an NLA for mobile entities according to various embodiments.

FIG. 5 is a flow diagram illustrating an embodiment of a process for identifying a current location of a mobile entity.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique for determining a location of a mobile entity using LIDAR is disclosed. A mobile entity (e.g., car, truck, motorcycle, recreational vehicle, sport utility vehicle, electric vehicle, bicycle, mobile device, smart phone, etc.) is configured to move within an environment that includes a plurality of assets. For example, the environment may include one or more traffic lights or signs, one or more plants, one or more buildings, one or more other mobile entities, one or more bridges, one or more railroad tracks, one or more people, etc. An asset may be fixed, pseudo-fixed, or non-fixed. The mobile entity is associated with a mobile system that includes one or more LIDAR sensors.

An initial location of the mobile entity may be unknown. In some embodiments, a GPS associated with the mobile entity provides a rough estimate (e.g., within 50 meters) of the initial location. In some embodiments, a user associated with the mobile entity provides the initial location of the mobile entity (e.g., San Francisco). In some embodiments, a last known location of the mobile entity is used as the initial location of the mobile entity. For example, the mobile entity may have been parked at a first location at the end of a first day. The first location may be used as the initial location for the mobile entity at the beginning of the second day.

The initial location of the mobile entity is provided to a LIDAR reference system (LRS). The LRS includes a plurality of reference maps associated with corresponding location. In response to receiving the initial location of the mobile entity, the LRS provides to the mobile entity a reference map corresponding to the initial location of the mobile entity. The LRS is configured to provide the mobile entity with one or more additional reference maps in response to receiving data that indicates the mobile entity is moving to a location that is not included in a previously provided reference map.

The reference map is loaded into a memory associated with the mobile entity. The reference map includes a plurality of reference localization points that is to be compared with observed environment lidar sensor data associated with the mobile entity to determine a location of the mobile entity.

In some embodiments, the LRS receives observed environment LIDAR sensor data from the one or more LIDAR sensors. In some embodiments, a processor associated with the mobile entity (e.g., computer processing unit (CPU), graphics processing unit (GPU), digital processing unit (DPU), etc.)) receives the observed environment LIDAR sensor data. The observed environment LIDAR sensor data includes a LIDAR point cloud of data. In some embodiments, the LIDAR point cloud of data is based on a current scan. In some embodiments, the LIDAR point cloud of data is based on a current scan and one or more previous scans (e.g., the scans from the last two seconds). In some embodiments, the LIDAR sensor associated with the mobile entity is the same type of LIDAR sensor used to generate the reference map. In some embodiments, the LIDAR sensor associated with the mobile entity is a different type of LIDAR sensor than the type of LIDAR sensor used to generate the reference map. As a result, a spatial density associated with the observed environment LIDAR sensor data may be different than a spatial density associated with the reference localization points included in the reference map. This may make it difficult and resource intensive to correlate the observed environment LIDAR sensor data with the reference localization points.

In some embodiments, the observed environment LIDAR sensor data is pre-processed (e.g., normalized) to match the spatial density associated with the reference localization points included in the reference map. In some embodiments, the spatial density associated with the observed environment LIDAR sensor data is upscaled to match the spatial density associated with the reference localization points included in the reference map. In some embodiments, the spatial density associated with the observed environment LIDAR sensor data is downscaled to match the spatial density associated with the reference localization points included in the reference map.

In some embodiments, the observed environment LIDAR sensor data is subsampled based on a speed associated with the mobile entity. In some embodiments, no sub-sampling occurs in the event the speed associated with the mobile entity is above a speed threshold (e.g., 10 m/s). In some embodiments, sub-sampling occurs in the event the speed associated with the mobile entity is not above the speed threshold (e.g., 0≤speed<10 m/s).

The observed environment LIDAR sensor data is transformed into one or more alternative observed environment candidates. The point of view at which the plurality of reference localization points included in the reference map were obtained (e.g., an angle) may be slightly different than the point of view at which the observed environment LIDAR sensor data was obtained. In some embodiments, the observed environment LIDAR sensor data is transformed to a different viewpoint by shifting the observed environment LIDAR sensor data in at least one of six degrees of freedom (e.g., X, Y, Z, roll, pitch, yaw). In some embodiments, the mobile entity includes an IMU. In such embodiments, the observed environment LIDAR sensor data is transformed to a different viewpoint by shifting the observed environment LIDAR sensor data in at least one of four degrees of freedom (e.g., X, Y, Z, yaw).

A corresponding observed environment reduced representation for the observed environment LIDAR sensor data and each of the one or more alternative observed environment candidates is calculated. The LIDAR sensor may produce thousands of point cloud points within a predefined 3-D region. The observed environment LIDAR sensor data and each of the one or more alternative observed environment candidates is associated with a corresponding predefined 3-D region. Due to the number of LIDAR points that may be generated by the LIDAR sensor, each of the predefined 3-D regions is subdivided into a corresponding plurality of 3-D subregions. A fingerprint is generated for each of the 3-D subregion. The fingerprint associated with a 3-D subregion represents a spatial density of point cloud points within the 3-D subregion. In some embodiments, the fingerprint associated with a 3-D subregion is representing by a 2-byte value. In some embodiments, a volume of a 3-D subregion is adjustable. In some embodiments, a volume of a 3-D subregion is fixed.

The observed environment reduced representations are correlated with the referenced reduced representations for different geographical locations to determine correlation results. The reference map includes a plurality of localization points within a reference 3-D region. The reference 3-D region associated with the reference map is also subdivided into a plurality of 3-D subregions. A size of a 3-D subregion associated with the observed environment data is the same size as a 3-D subregion associated with the reference map. Each of the 3-D subregions associated with the reference map has a corresponding fingerprint. The fingerprints of the observed environment reduced representations for the observed environment LIDAR sensor data and each of the one or more alternative observed environment candidates are compared with the fingerprints associated with the reference map.

The mobile entity determines whether a number of matches associated with the observed environment LIDAR sensor data and each of the one or more alternative observed environment candidates is above a match threshold. In response to a determination that the number of matches associated with the observed environment LIDAR sensor data or one of the one or more alternative observed environment candidates is above the match threshold, a current location of the mobile entity is identified based on the matches. In some embodiments, the number of matches associated with the observed environment LIDAR sensor data and one or more of the alternative observed environment candidates is above the match threshold. In such embodiments, the location associated with the mobile entity is determined based on the point of view having the highest number of matches (e.g., either the observed environment LIDAR sensor data or one of the one or more alternative observed environment candidates).

In response to a determination that the number of matches associated with each of the one or more alternative observed environment candidates is not above a match threshold, the mobile entity shifts the point of view at which the observed environment LIDAR sensor data was obtained to transform the observed environment LIDAR sensor data into one or more additional alternative observed environment candidates. The above process repeats until a number of matches associated with one of the one or more alternative observed environment candidates is above the match threshold.

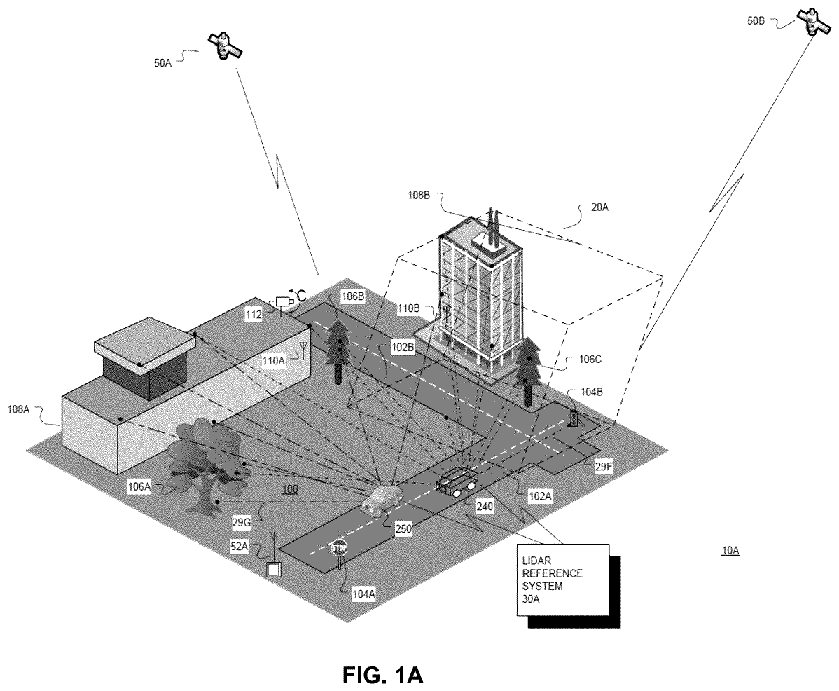

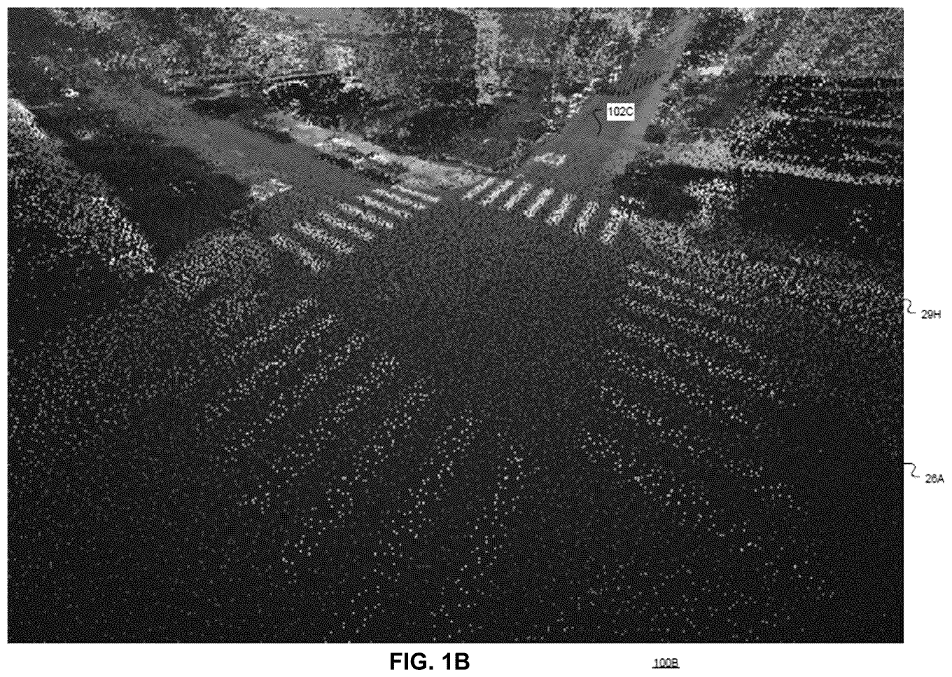

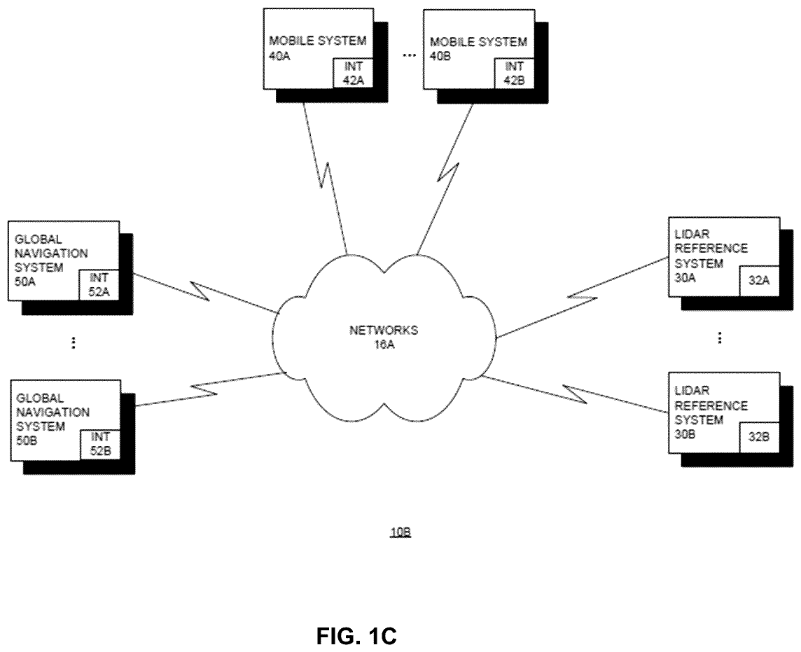

FIG. 1A is a simplified diagram of a navigation and location architecture (NLA) 10A for mobile entities 240, 250 according to various embodiments. In the example shown, NLA 10A includes one or more mobile entities 240, 250 moving about an environment 100, a LRS 30A, and one or more global navigation systems (GNS) 50A, 50B. Environment 100 may include one or more navigational pathways 102A, 102B, navigational pathway signs or navigation pathway control signals 104A, 104B, plants or natural assets 106A, 106B, 106C, and buildings 108A, 108B. In some embodiments, the one or more navigational pathways 102A, 102B, the navigational pathway signs or navigation pathway control signals 104A, 104B, the plants or natural assets 106A, 106B, 106C, and the buildings 108A, 108B are considered fixed assets or pseudo-fixed assets in an environment. In some embodiments, one or more assets 102A-108B may include image, radar, LIDAR, WiFi, Bluetooth, other wireless signal data generation modules 110A, 110B, 112 that provide signals that may be received by a mobile entity 240, 250, or LRS 30.

In some embodiments, the mobile entities 240, 250, or LRS 30 via mobile entities 240, 250 receive positional information and LIDAR data from one or more assets 102A-108B. In some embodiments, the ME 240, 250, or LRS 30 receives positional information from a global navigation systems (GNS) 50A, 50B such as US Global Positioning System (GPS), GLONASS (Russia), Galileo (EU), BeiDou (China) and regional systems QZSS (Japan), and IRNSS or NavIC (India).

Environment 100 may include a topology with fixed or pseudo-fixed navigation areas where a mobile entity may navigate or is permitted to move. Such an environment may also include pseudo-fixed assets such as buildings, corridors, streets, pathways, canals, navigational markings, plants (such as trees), and natural attributes such as rivers, bodies of water, changes in elevation (such as hills, valleys, mountains). These assets may be termed pseudo-fixed assets as building may be modified (e.g., under construction or renovated), trees planted, moved, or cut down, leaves falling off or growing on a plant depending on the time of year, rivers dammed or bridged, tunnels formed in mountains. Even the topology and fixed or pseudo-fixed navigation areas may change with the addition or removal of pathways (roads or bridges moved, changed, or removed). Environment 100 may include a topology that includes one or more non-fixed assets (e.g., other moving vehicles, pedestrians, animals, etc.)

In some embodiments, a first mobile entity (e.g., mobile entities 240, 250) may be employed to collect machine vision-based information (referenced data) of environment 100 to be navigated along with higher or lower degrees of accuracy or precision location data, where the environment may include one or more fixed assets, one or more pseudo-fixed assets, and/or one or more non-fixed assets. The machine vision-based information (reference localization points) about the environment 100 may include precise reference points or point cloud data that may indicate the precise location of various elements in the environment relative to the first mobile entity. The first mobile entity may forward the vision-based information of environment 100 along with high precision location data to LRS 30A for processing. In response to receiving the vision-based information, LRS 30A may generate fingerprints of the received localization points (e.g., reference reduced representations for different geographical locations). In an embodiment, the fingerprint data may represent analysis of three-dimensional (3D) regions 20A of the environment 100.

As a second mobile entity (e.g., mobile entity 240, 250) moves about environment 100, it may also obtain machine vision-based information about its region. In some embodiments, the second mobile entity communicates their machine vision-based information (e.g., observed environment LIDAR sensor data) to LRS 30A. In some embodiments, the second mobile entity is configured to communicate their initial location information (e.g., initial location determined from GPS) to LRS 30A and to request a reference map and/or a subset of reference fingerprint data proximate the second mobile entity's initial location (e.g., machine vision-based information of 3-D region 20A of the environment 100). In response, LRS 30A is configured to provide the reference map and/or the related subset of reference fingerprint data (e.g., machine vision-based information of 3D region 20A of the environment 100) to the second mobile entity based on the provided location information. The reference map includes a plurality of reference localization points that are to be compared with observed environment lidar sensor data associated with the mobile entity to determine a location of the mobile entity. In some embodiments, the second mobile entity is configured to correlate the received machine vision-based information of the 3D region 20A of environment 100 with its own obtained machine vision-based information about its region to determine its precise location. In an embodiment, the machine vision-based information may include LIDAR information.

The second mobile entity or LRS 30A may transform the observed environment LIDAR sensor data into one or more alternative observed environment candidates, calculate a corresponding observed environment reduced representation for the observed environment LIDAR sensor data and each of the one or more alternative observed environment candidates, and correlate the observed environment reduced representations with referenced reduced representations for different geographical locations to determine correlations, and based on the correlation results, determine a location of the second mobile entity. In some embodiments, the second mobile entity or LRS 30A includes a graphics processing unit (GPU). The GPU may be utilized to perform steps 308, 310, 312, 314 in parallel for a plurality of alternative observed environment candidates (e.g., a batch of alternative observed environment candidates). Utilizing the GPU reduces the amount of time needed to identify the current location of the mobile entity.

The second mobile entity or LRS 30A is configured to transform the observed environment LIDAR sensor data into one or more alternative observed environment candidates by shifting the observed environment LIDAR sensor data in at least one of six degrees of freedom (e.g., X, Y, Z, roll, pitch, yaw). In some embodiments, the mobile entity includes an IMU. In such embodiments, the observed environment LIDAR sensor data is transformed to a different viewpoint by shifting the observed environment LIDAR sensor data in at least one of four degrees of freedom (e.g., X, Y, Z, yaw).

The second mobile entity or LRS 30A is configured to calculate a corresponding observed environment reduced representation for the observed environment LIDAR sensor data and each of the one or more alternative observed environment candidates by subdividing a corresponding 3-D region associated with the observed environment LIDAR sensor data and each of the one or more alternative observed environment candidates into a corresponding plurality of 3-D subregions. A fingerprint is generated for each of the 3-D subregions. The fingerprint associated with a 3-D subregion represents a spatial density of point cloud points within the 3-D subregion. In some embodiments, the fingerprint associated with a 3-D subregion is representing by a 2-byte value. In some embodiments, a volume of a 3-D subregion is adjustable. In some embodiments, a volume of a 3-D subregion is fixed.

The second mobile entity or LRS 30A is configured to correlate the observed environment reduced representations with referenced reduced representations for different geographical locations to determine correlations. The reference map includes a plurality of localization points within a reference 3-D region. The reference 3-D region associated with the reference map is also subdivided into a plurality of 3-D subregions. A size of a 3-D subregion associated with the observed environment data is the same size as a 3-D subregion associated with the reference map. Each of the 3-D subregions associated with the reference map has a corresponding fingerprint. The fingerprints of the observed environment reduced representations for the observed environment LIDAR sensor data and each of the one or more alternative observed environment candidates are compared with the fingerprints associated with the reference map (e.g., determine whether the fingerprints match).

In some embodiments, the LRS 30A is configured to correlate the reference fingerprint data to the observed fingerprint data to determine the location of the second mobile entity using (based on the positional data tied to the reference fingerprint data)—absolute fingerprinting. In some embodiments, the LRS 30A is configured to correlate the reference fingerprint data to the observed fingerprint data based on the tied lower accuracy or precision location information (of the observed data) to determine the location of the second mobile entity (based on the more precise positional data tied to the reference fingerprint data)—relative fingerprinting. In some embodiments, LRS 30A is configured to then communicate the determined mobile entity location to the second mobile entity.

The second mobile entity or LRS 30A is configured to determine whether a number of matches associated with the observed environment LIDAR sensor data and each of the one or more alternative observed environment candidates is above a match threshold. In response to a determination that the number of matches associated with the observed environment LIDAR sensor data or one of the one or more alternative observed environment candidates is above the match threshold, a current location of the mobile entity is identified based on the matches. That is, a current location of the mobile entity with respect to the reference map is determined. In some embodiments, the number of matches associated with the observed environment LIDAR sensor data and one or more of the one or more alternative observed environment candidates is above the match threshold. In such embodiments, the location associated with the mobile entity is determined based on the point of view having the highest number of matches (e.g., either the observed environment LIDAR sensor data or one of the one or more alternative observed environment candidates).

In response to a determination that the number of matches associated with each of the one or more alternative observed environment candidates is not above a match threshold, the second mobile entity or LRS 30A shifts the point of view at which the observed environment LIDAR sensor data was obtained to transform the observed environment LIDAR sensor data into one or more additional alternative observed environment candidates. The above process repeats until a number of matches associated with one of the one or more alternative observed environment candidates is above the match threshold.

In some embodiments, machine vision-based information (reference data) of environment 100 may be anchored to positional data (reference data tied to positional data). In some embodiments, the machine vision-based information of environment 100 includes point cloud data and the point cloud data is anchored to positional data (such as GPS data). The reference data tied to positional data may be used by a LRS 30A to form reference fingerprint data (presenting machine vision-based 3D region 20A of environment 100 in an embodiment). The GPS data tied to the reference data may be high accuracy or precision location data, such as surveyor licensed GPS data that enables LRS 30A to form reference data tied to positional data, such as machine vision-based 3D regions 20A of the environment 100 anchored with positionally accurate or precise location information.

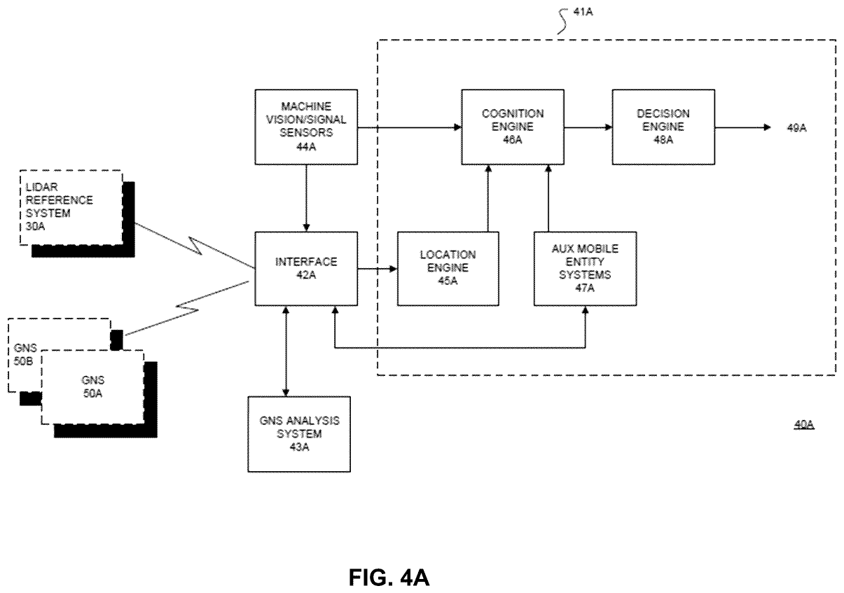

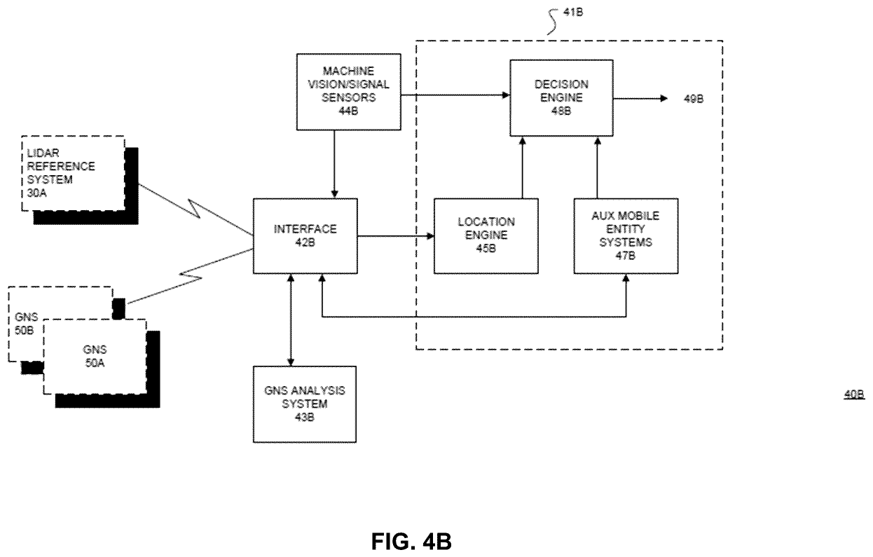

LIDAR cloud data anchored with high accuracy or precision location information may provide precisely-located known points of reference for a mobile entity 240, 250 including the location of devices that generate image, radar, LIDAR, WiFi, Bluetooth, other wireless signal data of an asset 102A-108B such as show in FIG. 4A (reference data tied to positional data). In particular, in the embodiment of FIG. 4A, LIDAR reference points 29B-29D may represent various locations on the tree 106C and reference points 29E-29F may represent locations on the navigation pathway control signal 104B. Further, reference point 29E may represent a location on the navigation pathway control signal 104B. In an embodiment, each reference or point cloud datum 29B-F may have an associated location position generated in part from the GPS signals including survey level signals.

A LIDAR sensor associated with a mobile entity may measure distances to fixed or pseudo-fixed navigation areas and pseudo-fixed assets by illuminating the fixed or pseudo-fixed navigation areas and pseudo-fixed assets with pulsed laser light and measuring the reflected pulses with sensors. Such distance determinations may also generate or calculate the heights and locations of the illuminated fixed or pseudo-fixed navigation areas and pseudo-fixed assets at multiple locations based on the known altitude of the LIDAR unit. The determined locations are termed point cloud datums.

In some embodiments, LRS 30A is configured to use or receive publicly available LIDAR point cloud data sets to enhance its reference data including data sets available from a US geographical survey.

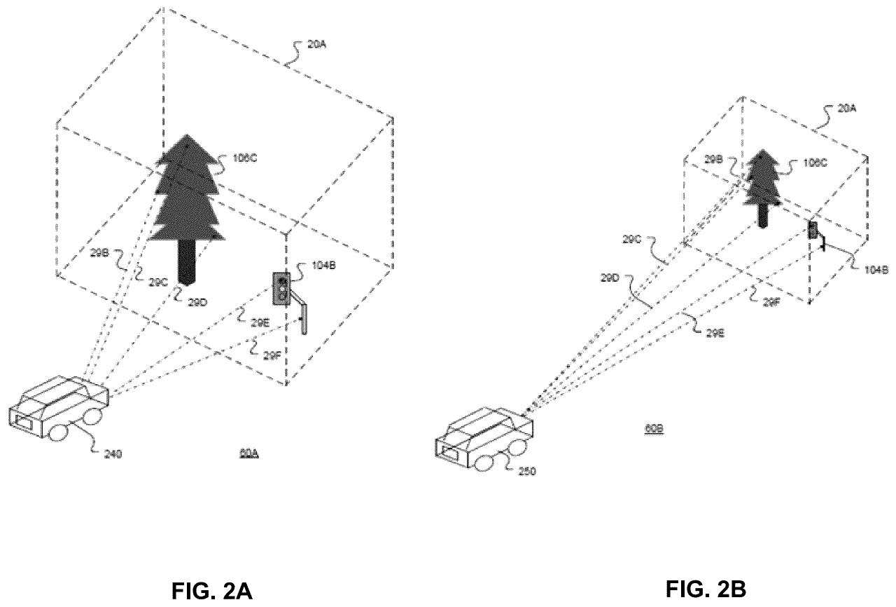

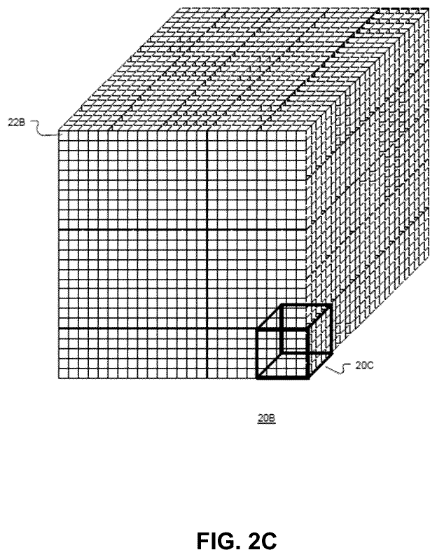

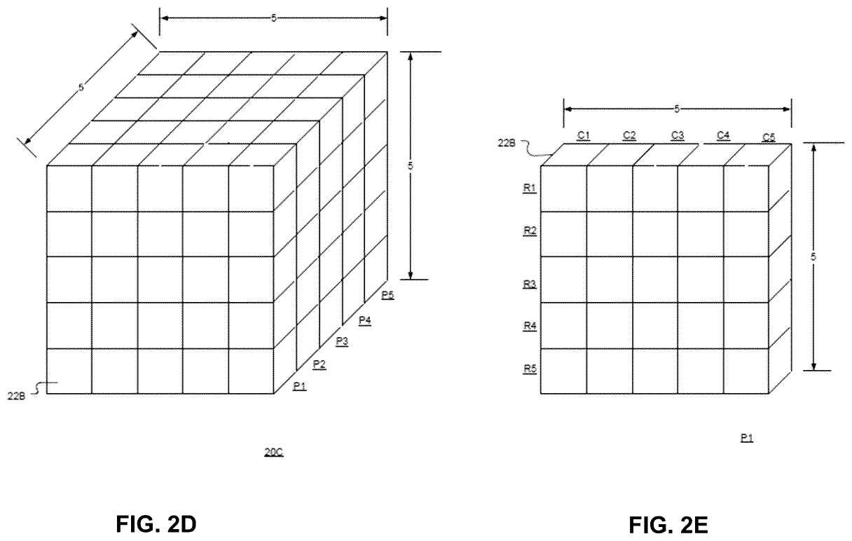

FIG. 1B is a simplified digital image 26A of an environmental region 100B that may be generated in part by a mobile entity according to various embodiments. As shown in FIG. 1B, the digital image 26A may include many overlaid LIDAR points 29H, which may be used in part to create a 3D model (e.g., FIG. 2C) of the assets 102C in the image.

FIG. 1C is a block diagram of a system for determining locations of mobile entities in accordance with various embodiments. In the example shown, system 10B includes mobile systems (MS) 40A, 40B of mobile entities 240, 250, respectively. MS 40A, 40B may be employed at one or more locations to work independently or collectively to with one or more LRS 30A-B and GNS 50A-50B. Similarly, system 10B may include several LRS 30A-B that may be employed at one or more locations to work independently or collectively with one or more MS 40A-B. The networks 16A may include a wireless network including local internet protocol-based network, cellular network, satellite network, or combination thereof.

A plurality of GNS 50A, 50B may also communicate with an LRS 30A, 30B, and MS 40A, 40B via one or more networks 16A. The networks 16A may include a wireless network including local internet protocol-based network, cellular network, satellite network, or combination thereof. A GNS 50A, 50B may each include a wireless communication interface 52A, 52B that enables real-time wireless communication with an LRS 30A, 30B, and MS 40A, 40B. Similarly, an LRS 30A, 30B, and MS 40A, 40B may each include a wireless communication interface 32A-42B that enables real-time wireless communication with a GNS 50A, 50B.

The networks 16A may include a wireless network including local internet protocol-based network, cellular network, satellite network, or combination thereof and wired network. An LRS 30A, 30B may communicate with an MS 40A-B to receive reference data, location data, and observed data in real-time via a wireless network and in batch mode via a wireless or wired network. In an embodiment, an LRS 30A, 30B may be co-located with an MS 240, 250 and communicate between each other in real-time via wireless or wired communication networks.

As shown in FIGS. 2A and 2B, a MS 40A of a mobile entity 240, 250 may generate LIDAR points (pixels 29B-29F) in a 3-D space as part of a point cloud. The data from a first MS 40A (or other reference mapping system) associated with a first mobile entity may generate reference data and a second MS 40A may collect observed data as a second mobile entity navigates about an environment. As shown in FIGS. 2A and 2B, LIDAR point cloud pixels may form 3-D space in the form of cubes (e.g., a voxel). Due to the number of pixels that may be generated by LIDAR sensors, the observed and reference data may be subdivided into smaller 3-D subregions 22B such as shown in FIG. 2C.

### Lidar Fingerprinting Examples

A LIDAR sensor may produce thousands of point cloud points within a predefined 3-D region. Attempting to correlate thousands of LIDAR point cloud points between reference data and observed data may consume substantial resources particularly when only rough prior known location data (Relative Fingerprinting) or no prior known location data (Absolute Fingerprinting) is available or used. The density distribution of LIDAR points in a given 3D area may be evaluated in order to derive a characterization of the 3D area that is unique or substantially unique, either individually or in combination with other nearby density distribution characterizations. Such fingerprints or density distribution characterizations may then be utilized to correlate or align reference data with observed environment LIDAR sensor data. Using fingerprints to align the reference data (e.g., reference localization points) with the observed environment LIDAR sensor data reduces the amount of CPU resources needed to identify the current location of the mobile entity.

In an exemplary embodiment with reference to FIG. 2C, LRS 30A and a processor associated with a mobile entity (e.g., cognition engine 36A, 46A) may determine the number of LIDAR cloud points or pixels that fall into each pre-defined 3-D region (micro-region) 22B, essentially determining the density of LIDAR data within each sub-regions 22B forming a fingerprint of the LIDAR data within a region 20B. However, the absolute number of point cloud points within a given 3-D region may vary based on factors such as the distance of a LIDAR sensor from the observed area, details of the LIDAR sensor specifications, ambient conditions (e.g. weather), or other factors. For this and other reasons, it may be preferable in practice to generate a fingerprint for a given 3D region based on relative point cloud densities within subregions of the 3-D region being characterized.

In one exemplary embodiment of density-based fingerprinting, a 3-D region 20A (FIGS. 2A-B) may be divided in a number of smaller 3-D subregions 20C as seen in FIG. 2D. Each subregion 20C may be characterized based on a 5×5×5 array of micro-regions 22B (typically cubic volumes). For example, if region 20C defined a cubic 3-D space that is 5 meters per side in length, then, as seen in FIG. 2E, region 20C comprises 125 smaller micro-regions 22B that are 1 cubic meter each in volume. As noted above, the cubes may preferably be scaled to the same size between reference and observed data to help correlation between regions. Fingerprints of each smaller 3-D subregion or cube 20C may then be determined by counting the number of LIDAR points within each micro-region 22B within a region 20C, and ranking the regions by LIDAR point density.

In particular, one approach to fingerprinting of referenced and observed data that has been found to be effective in some applications involved determining a fingerprint for a cube 20C by evaluating the LIDAR point density of its 3-D space plane by plane (P1:P5 of a 5×5×5 3-D space as shown in FIG. 4D). The LIDAR point density of each micro-region 22B (number of LIDAR points within each cube) of a plane P1:P5 may be determined. Then, the sum of the density of each cube 22B in each row R1:R5 and in each column C1:C5 may be determined for each plane P1:P5. The row(s) and column(s) having the greatest number of LIDAR points (pixels) in their respective cubes 22B may be determined.

For example, in an embodiment, a LRS 30A and a processor associated with a mobile entity (e.g., cognition engine 46A) may determine the rows R1:R5 having the first and the second greatest number of LIDAR points (density) and the columns C1:C5 having the first and the second greatest number of LIDAR points (density) for each plane P1:P5 of a cube 20C. Indications of the rows R1:R5 and columns C1:C5 having the first and second greatest number of LIDAR points therein for each Plane P1:P5 may represent the signature or fingerprint of the 3-D space—cube 20C.

For example, if R1 and R3 and C2 and C4 have the greatest number of LIDAR points (falling within the cubes of the respective rows and columns in the respective plane P1:P5, then P1 density pattern, signature, or fingerprint may be 1324. For five planes P1:P5 the density pattern, signature, or fingerprint for the entire cube may be represented as a list of 20 numbers (4 per plane) where each number is an integer in the range from 1 to 5. Using compression, an effective density measurement or fingerprint of each 5×5×5 cube 20C may be represented by a small number of bits, such as two 8-bits words. This density measurement representing the fingerprint for a 3-D space may be determined for reference LIDAR points and the observed LIDAR points in an embodiment.

### Lidar Relative Fingerprinting

As described above, LRS 30A may provide a particular subset of density mapped reference data anchored with more precise location information (i.e. reference fingerprint data) to a MS 40A, where the subset is selected based on its proximity to, e.g. rough positional information from a MS 40A. In some embodiments, the rough positional information is determined based on a GPS signal. In some embodiments, the rough positional information is provided by a user input. In some embodiments, the rough positional information is determined based on a last known location associated with the MS 40A. In some embodiments, other factors may also be utilized in selecting reference data to be used by MS 40A for comparison to observed data. For example, reference data may be provided to MS 40A based at least in part on a direction and/or velocity of travel of MS 40A, and/or a planned route of travel for MS 40A. In some embodiments, reference data will be selected to maximize the likelihood that the reference data characterizes locations and assets that will be observable by MS 40A.

The processor associated with a mobile entity (e.g., cognition engine 46A) or LRS 30A may compare the density mapped reference data (reference fingerprint) to the observed environment LIDAR sensor data to find the greatest correlation between both. In some embodiments, such a comparison may be implemented by application of gradient descent optimization techniques. In some embodiment, a cube's 20C space may be shifted one or more rows, columns, or planes at a time in the region 20A representing observed data or reference data, its new fingerprint determined and then compared to the fingerprint of the other of the referenced data or observed data until the greatest fingerprint match (similar rows and columns having the greatest number of LIDAR data points) is located. This correlation process may yield a multidimensional error surface, with the point of maximum alignment determined to be the alignment having the most fingerprint matches. Then the positional data associated with the matched reference data may be applied to matched observed data. MS 40A may then determine its position by offsetting from the matched, observed fingerprint locations by the observed distance of MS 40A from those observed fingerprints. Such a positioning technique has been found in some applications to be highly reliable, tolerant of noise, and relatively insensitive to sensor specifications or calibration.

### Lidar Absolute Fingerprinting

In some embodiments, MS 40A may not provide or be able to determine sufficient information about its starting position to reasonably facilitate certain localization approaches described herein. For example, MS 40A may possess insufficient information about its current position to select a subset of reference map information against which to correlate observed data. In such an embodiment or to more efficiently match density (fingerprint) data, a LRS 30A or MS 40A may orient their LIDAR data based on anchors, e.g. landmarks, prior to performing density analysis (determining the observed data and reference data fingerprint). Such anchors may be identified from the point cloud data, particularly given knowledge concerning a local environment associated with the point cloud data.

For example, where LIDAR data is collected in an urban environment, it may be assumed that a road surface is generally flat and defines a ground level. Ground level may thus be identified from LIDAR data and used to remove a Z variable in the process of correlating observed and reference data. In other words, the Z position or elevation of a mobile entity 240, 250 may be assumed based on a ground level derived from LIDAR point cloud data, thereby reducing variables for optimization in aligning observed data with reference data. In other words, assumptions about a mobile entity's position relative to an anchor identified in point cloud data may be used to limit a reference cloud data search set. Combining such constraints with use of fingerprints (rather than computation on an entire point cloud) may significantly decrease the computational requirements for mobile entity localization to a level that is feasible for localization in real-time or near real-time (e.g. sufficiently quickly to enable practical navigation decisions in a particular application).

In particular, for a mobile entity employing LIDAR, the road surface, curbs, and other road related landmarks may be used to provide orientation of LIDAR data for both reference data and observed data. Then a cognition engine 46A with the mobile entity or LRS 30A may compare a constrained search set of oriented, density mapped (fingerprint) reference datasets to the oriented density mapped (fingerprint) observed dataset to find the greatest correlation between the observed data and one of the possible reference datasets. In an embodiment, a cube's 20C space may be shifted one row, column, or plane at a time in the region 20A representing oriented observed data or oriented reference data, its new fingerprint determined and then compared to the fingerprint of the other of the oriented referenced data or oriented observed data until the greatest fingerprint match (similar rows and columns having the greatest number of LIDAR data points) is located. Then the positional data associated with the matched reference data (reference fingerprint matched to observed fingerprint) may represent the location of the MS 40A.

For example, in some embodiments, anchoring relative to road surfaces, lane markings and curbs may be sufficient to reduce a search set of reference data to 1000 or fewer sets of reference data. Implementing certain embodiments described herein, Applicants have been able to perform a fingerprint matching process in approximately 5 milliseconds using a standard GPU. However, the matching calculations described herein may be highly parallelized. It is contemplated and understood that ASIC implementations of the matching calculation may be performed sufficiently quickly to enable practical, real-time LIDAR-only localization on-board a mobile entity.

In some embodiments, localization calculations described herein may be performed in the cloud, i.e. by a network-connected computing resource such as LRS 30A, with a resulting mobile entity position communicated back down to a mobile entity 240, 250. Such an approach may enable minimization of computation and storage resources on board a mobile, which may be particularly valuable for implementation of low-cost mobile entities such as small autonomous delivery robots. Cloud-based localization computations are facilitated by use of fingerprinting approaches described herein, particularly if a mobile entity 240, 250 performs fingerprinting based on observed LIDAR data on board the mobile entity. In such applications, a mobile entity may only need to transfer over a communications network a relatively small dataset comprising observed signatures (e.g. a relatively small list of integers), rather than transferring an entire point cloud over a network.

In some applications, such an approach utilizing cloud-based compute resources for localization may also facilitate initial localization of a mobile entity within a very large reference area, with little or no dependency on GPS or other prior localization knowledge, by applying very high amounts of centralized cloud computation and storage resources to such an initial location search computation. In some embodiments, a given mobile entity may only very sporadically require a high level of compute and storage resources, e.g. when little or no prior information is known regarding the mobile entity's initial location. Centralization of such computation and storage requirements (rather than, e.g., equipping each mobile entity with computation and storage resources sufficient to perform such “cold localizations”) may substantially reduce the aggregate computation and storage requirements of a given system.

Lack of GNS dependency for fast and accurate mobile localization may also be desirable for enabling reliable operation even in areas where GNS systems are unreliable or unavailable. For example, in sidewalk delivery robot applications, tree cover over many sidewalk areas may impair the operation of common GNS systems. In some environments (particularly urban environments), nearby buildings may block or reflect GNS signals. By removing or reducing reliance on GNS systems for precise mobile localization, improved or additional use cases may be available.

In some embodiments, mobile entity operation may be facilitated in areas in which both GNS and other wireless communications are unavailable or undesirable. For example, in underground tunnels or certain indoor environments. An expected route may be determined for a mobile entity and a reference map (e.g. fingerprint data) for areas proximate the expected navigation route may be downloaded and stored within the mobile entity prior to navigation. The mobile entity may then use LIDAR-only localization techniques described herein to correlate observed data with downloaded reference data to precisely localize the mobile entity along the intended route without reliance on any external data connectivity or wireless communications whatsoever.

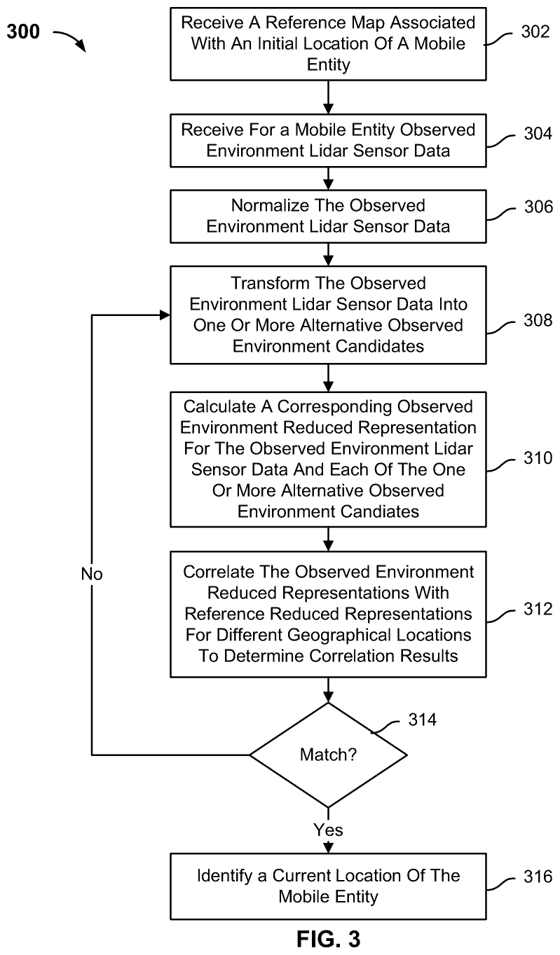

FIG. 3 is a flow diagram illustrating an embodiment of a process for identifying a current location of a mobile entity. In the example shown, process 300 may be implemented by a mobile entity, such as mobile entity 240, 250. In some embodiments, process 300 is implemented by a LRS, such as LRS 30A.

At 302, a reference map associated with an initial location of a mobile entity is received. A LIDAR reference system includes a plurality of reference maps associated with different locations. In response to receiving the initial location of the mobile entity, the LIDAR reference system provides to the mobile entity a reference map corresponding to the initial location of the mobile entity. Step 302 may be optional when process 300 is performed by an LRS.

In some embodiments, an estimated location determined by a GPS associated with the mobile entity (e.g., within 50 meters) is used as the initial location. In some embodiments, an estimated location provided by a user associated with the mobile entity is used as the initial location (e.g., San Francisco). In some embodiments, a last known location of the mobile entity is used as the initial location of the mobile entity. For example, the mobile entity may have been parked at a first location at the end of a first day. The first location may be used as the initial location for the mobile entity at the beginning of the second day.

At 304, observed environment LIDAR sensor data is received for a mobile entity. The observed environment lidar sensor data includes a plurality of spatial points. The observed environment LIDAR sensor data includes a LIDAR point cloud of data. In some embodiments, the LIDAR point cloud of data is based on a current scan. In some embodiments, the LIDAR point cloud of data is based on a current scan and one or more previous scans (e.g., the scans from the last two seconds). In some embodiments, the LIDAR sensor associated with the mobile entity is the same type of LIDAR sensor used to generate the reference map. In some embodiments, the LIDAR sensor associated with the mobile entity is a different type LIDAR sensor than the type LIDAR sensor used to generate the reference map. As a result, a spatial density associated with the observed environment LIDAR sensor data may be different than a spatial density associated with the reference localization points included in the reference map.

At 306, the observed environment lidar sensor data is normalized to match the spatial density associated with the reference localization points included in the reference map. In some embodiments, the spatial density associated with the observed environment LIDAR sensor data is upscaled to match the spatial density associated with the reference localization points included in the reference map. In some embodiments, the spatial density associated with the observed environment LIDAR sensor data is downscaled to match the spatial density associated with the reference localization points included in the reference map. In some embodiments, an average value of a plurality of the observed environment LIDAR sensor data points in a 3D sub-region is determined. In some embodiments, an average value of a plurality of the reference LIDAR sensor data points for a reference 3D sub-region is also determined. In some embodiments, step 306 is optional when the LIDAR sensor associated with the mobile entity is the same type of LIDAR sensor used to generate the reference map.

In some embodiments, the observed environment LIDAR sensor data is subsampled based on a speed associated with the mobile entity. In some embodiments, no sub-sampling occurs in the event the speed associated with the mobile entity is above a speed threshold (e.g., 10 m/s). In some embodiments, sub-sampling occurs in the event the speed associated with the mobile entity is not above the speed threshold (e.g., 0≤speed<10 m/s).

At 308, the observed environment lidar sensor data is transformed into one or more alternative observed environment candidates. The point of view at which the plurality of reference localization points included in the reference map were obtained (e.g., an angle) may be slightly different than the point of view at which the observed environment LIDAR sensor data was obtained. In some embodiments, the observed environment LIDAR sensor data is transformed to a different viewpoint (i.e., an alternative observed environment candidate) by shifting the observed environment LIDAR sensor data in at least one of six degrees of freedom (e.g., X, Y, Z, roll, pitch, yaw). In some embodiments, the mobile entity includes an IMU. In such embodiments, the observed environment LIDAR sensor data is transformed to a different viewpoint by shifting the observed environment LIDAR sensor data in at least one of four degrees of freedom (e.g., X, Y, Z, yaw).

At 310, a corresponding observed environment reduced representation for the observed environment LIDAR sensor data and each of the one or more alternative observed environment candidates is calculated. The LIDAR sensor may produce thousands of point cloud points within a predefined 3-D region. The observed environment LIDAR sensor data and each of the one or more alternative observed environment candidates is associated with a corresponding predefined 3-D region. Due to the number of LIDAR points that may be generated by the LIDAR sensor, the each of the predefined 3-D regions is subdivided into a corresponding plurality of 3-D subregions. A fingerprint is generated for each of the 3-D subregion. In some embodiments, the fingerprint is generated using a deep neural network. The fingerprint associated with a 3-D subregion represents a spatial density of point cloud points within the 3-D subregion. In some embodiments, the fingerprint associated with a 3-D subregion is representing by a 2-byte value. In some embodiments, a volume of a 3-D subregion is adjustable. In some embodiments, a volume of a 3-D subregion is fixed.

At 312, the observed environment reduced representations are correlated with referenced reduced representations for different geographical locations to determine correlation results. The reference map includes a plurality of localization points within a reference 3-D region. The reference 3-D region associated with the reference map is also subdivided into a plurality of 3-D subregions. A size of a 3-D subregion associated with the observed environment data or an alternative observed environment candidate is the same size as a 3-D subregion associated with the reference map. Each of the 3-D subregions associated with the reference map has a corresponding fingerprint. The fingerprints of the observed environment reduced representations for the observed environment LIDAR sensor data and each of the one or more alternative observed environment candidates are compared with the fingerprints associated with the reference map.

At 314, it is determined whether a number of matches associated with the observed environment LIDAR sensor data and each of the one or more alternative observed environment candidates is above a match threshold. In response to a determination that the number of matches associated with the observed environment LIDAR sensor data or one of the one or more alternative observed environment candidates is above the match threshold, process 300 proceeds to 316. In some embodiments, the number of matches associated with the observed environment LIDAR sensor data and one or more of the alternative observed environment candidates is above the match threshold. In such embodiments, the location associated with the mobile entity is determined based on the point of view having the highest number of matches (e.g., either the observed environment LIDAR sensor data or one of the one or more alternative observed environment candidates).

In response to a determination that the number of matches associated with each of the one or more alternative observed environment candidates is not above a match threshold, process 300 returns to step 308 where the mobile entity shifts the point of view at which the observed environment LIDAR sensor data was obtained into one or more additional alternative observed environment candidates.

At 316, a current location of the mobile entity is identified based on the correlation results.

FIG. 4A is a block diagram of a mobile system 40A that may be employed in NLA 10A to provide reference data of environment 100 and enable a mobile entity (e.g., mobile entity 240, 250) to navigate an environment 100 according to various embodiments. As shown in FIG. 4A, MS 40A may include machine vision/signal sensors 44A, a GNS analysis system 43A, a cognition engine 46A, a location engine 45A, auxiliary mobile entity systems 47A, an interface 42A, and a decision engine 48A.

As noted, a MS 40A may be employed to collect environmental data and provide the data to LRS 30A via an interface 42A where the environmental data may include machine vison data generated by sensors 44A and positional data generated by GNS analysis system 43A (e.g., position data within 50 meters). For a MS 40A only employed for this functionality, some or all of the elements in area 41A may not be active or included in MS 40A. In an embodiment, the machine vision/signal sensors 44A may include LIDAR sensors and generate LIDAR point cloud data. The GNS analysis system 43A may decode GNS signals received from a plurality of GNS 50A-B. In an embodiment, the GNS analysis system 43A may be able to decode GNS signals to various degrees of positional accuracy and/or precision from 50 ft to centimeters.

Additionally or alternatively to collecting reference data, MS 40A may operate to precisely position itself within, and navigate, environment 100. In some embodiments, MS 40A may collect rough location information via the GNS analysis system 40A (e.g., an initial location) and LIDAR data via the machine vision/signal sensors 44A. The machine vision/signal sensors 44A, 44B, 44C, may include LIDAR units, digital image sensors, radar generation and receivers, and signal processors. The signal processors may analyze wireless signals to determine location based on knowledge of wireless signal antenna(s) 110A, 110B where the wireless signals may be received by the sensors 44A or interface 42A. The wireless signals may be Wifi, cellular, Bluetooth, WiMax, Zigbee, or other wireless signals. The location engine 45A may use the GNS analysis system 43A data and machine vision/signal sensors 44A to generate an estimate of the MS 40A current location.

A MS 40A may provide its determined location information to LRS 30A via interface 42A. The mobile system 40A may also send additional data to LRS 30A including auxiliary mobile entity information including known axis information, speed, and direction, position and pose-orientation of the first mobile entity. Based on the received location information, LRS 30A may provide reference LIDAR data anchored with precise location information to MS 40A via the interface 42A.

The image, radar, LIDAR, WiFi, Bluetooth, other wireless signal data captured via sensors 44A-B may be correlated with reference LIDAR data received from LRS 30A via the cognition engine 46A to determine a location of mobile entity 240, 250 in an embodiment. As noted, a mobile entity 40A may also forward image, radar, LIDAR, WiFi, Bluetooth, other wireless signal data in addition to location data to an LRS 30A.

In some embodiments, the auxiliary mobile entity system 47A may include an IMU that measures and reports specific force, angular rate, and sometimes the orientation of the MS 40A in a mobile system using a combination of accelerometers, gyroscopes, and sometimes magnetometers. The auxiliary mobile entity system 47A may also include a wheel odometry or other odometry that may use data from motion sensors to estimate change in position of a mobile entity over time. The auxiliary mobile entity system 47A data may also be used by the cognition engine 46A in addition to sensors 44A data and LRS 30A reference data.

Cognition engine 45A may attempt to correlate LIDAR point cloud data from sensors 44A (observed environment LIDAR sensor data) with reference LIDAR cloud data tied to precise location anchors received from LRS 30A. As noted, LIDAR sensors measure the distance to an object via laser(s): transmitting a beam and measuring the reflected beam with a sensor. The measured returned times and beam wavelength(s) may be employed to generate digital 3-D representations of the objects (such as 106C and 104B in FIGS. 4A-B). A LIDAR sensor may generate point clouds including over ten thousand pixels (or points) for each measurement. Such volume of data may difficult to communicate between an LRS 30A and a mobile entity and computationally intensive to process to determine possible correlation between LRS 30A LIDAR point cloud data and MS 40A collected LIDAR point cloud data.

LRS 30A may generate reference fingerprint data tied to location data based on the received reference data tied to positional data and forward the reference fingerprint data to MS 40A. Cognition engine 46A may generate observed fingerprint data. In some embodiments, the observed fingerprint data may represent the density of data within 3-D regions represented by the observed environment LIDAR sensor data. The observed fingerprint data may be scaled (upscaled or downscaled) to represent particular sized 3-D regions. Such scaling may be required or beneficial in order to correlate the observed fingerprint data to referenced fingerprint data provided by a LRS 30 (relative fingerprinting).

Cognition engine 46A may then correlate the determined observed fingerprint data to the received fingerprint data to determine to the location of MS 40A. For example, reference fingerprint data and observed fingerprint data may be derived from or related to the 3-D density of region 20A of LIDAR point cloud (both reference and observed, respectively). In some embodiment, LRS 30A determines reference or observed fingerprint data (e.g., the 3-D density of region 20A of LIDAR point cloud (both reference and observed)) and determines the highest correlation between the fingerprints (density characterizations) to effectively match LIDAR point clouds. In some embodiment, MS 40A determines reference or observed fingerprint data (e.g., the 3-D density of region 20A of LIDAR point cloud (both reference and observed)) and determines the highest correlation between the fingerprints (density characterizations) to effectively match LIDAR point clouds.

A number of other variations on systems and techniques described herein may be implemented. For example, FIG. 4B is a block diagram of another mobile system 40B that may be employed in navigation and location architecture 10A for mobile entities 240 according to various embodiments. As shown in FIG. 4B, MS 40B is similar to MS 40A but does not include a cognition engine 46A. As noted, a MS 40B may provide a captured image, radar, LIDAR, WiFi, Bluetooth, other wireless signal data 43 and related data to an LRS 30A. The LRS 30A may provide location, related image, radar, LIDAR, WiFi, Bluetooth, other wireless signal data information to the MS 40B via the interface 42B reducing the functionality and thus hardware needed in a MS 40B enabling a MS 40B to be employed in more and smaller ME 240. In an embodiment, the LRS 30A may receive observed LIDAR and positional data from a MS 40B and process the data using density matching to determine the location of the MS 40B (use relative fingerprinting or absolute fingerprinting or a combination of both in an embodiment). The LRS 30A may forward the determined location of the ME 240, 250 to the requesting MS 40A.

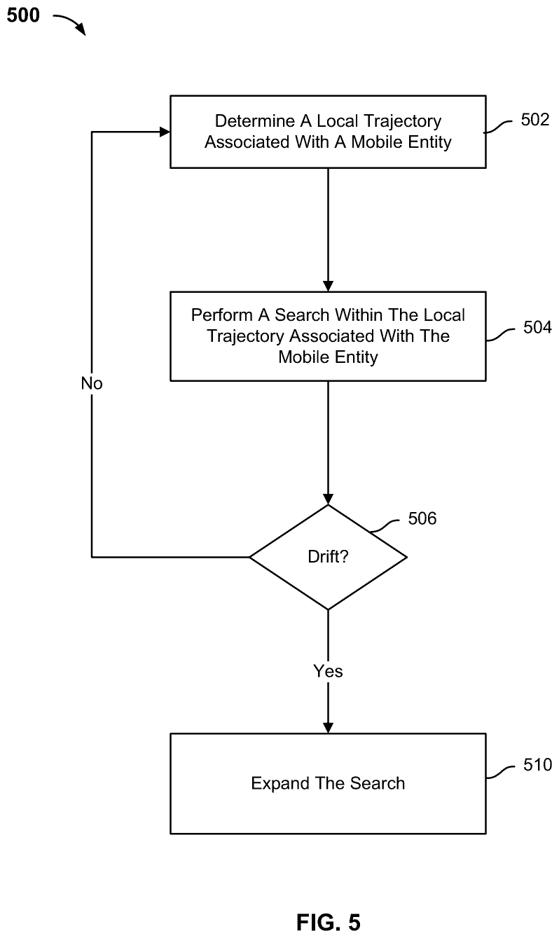

FIG. 5 is a flow diagram illustrating an embodiment of a process for identifying a current location of a mobile entity. In the example shown, process 500 may be implemented by a mobile entity, such as mobile entity 240, 250. In some embodiments, process 300 is implemented by a LRS, such as LRS 30A.

At 502, a local trajectory associated with a mobile entity is determined. A local trajectory of the mobile entity is determined based on aggregated, rectified LIDAR frames. The LIDAR frames can be rectified by using a current estimated speed of the LIDAR. Multiple frames (e.g., data from multiple scans) can be aggregated together to create a more rich point cloud of a scene than from a single frame.

At 504, a search within the local trajectory associated with the mobile entity is performed. For example, steps 308, 310, 312, 214, and 316 may be performed within the local trajectory associated with the mobile entity.

A reference map includes a plurality of potential locations for a mobile entity. The entirety of the reference map may be searched to determine a location of the mobile entity. However, such a search requires a large number of computation resources. The local trajectory associated with the mobile entity is used to reduce the number of computation resources used to determine the location of the mobile entity with respect to the reference map.

At 506, it is determined whether there is odometry drift. Distortions in the point cloud will reduce the accuracy and matching confidence. In the event the odometry drift is greater than a threshold amount, process 500 proceeds to 508. In the event the odometry drift is not greater than the threshold amount, process 500 returns to 502 where the local trajectory associated with the mobile entity is determined again as the mobile entity continues to move.

At 510, the search is expanded to include portions of the reference map that are outside of the local trajectory associated with the mobile entity. For example, absolute fingerprinting described above may be performed to determine the current location of the vehicle.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving for a mobile entity, observed environment lidar sensor data including a plurality of spatial points;
transforming the observed environment lidar sensor data into one or more alternative observed environment candidates;
calculating a corresponding observed environment reduced representation for the observed environment lidar sensor data and each of the one or more alternative observed environment candidates;
correlating the observed environment reduced representations with reference reduced representations for different geographical locations to determine correlation results; and
based on the correlation results, identifying a current location of the mobile entity.

2. The method of claim 1, further comprising receiving a reference map associated with an initial location of the mobile entity.

3. The method of claim 2, wherein the initial location of the mobile entity is an estimated location based on a GPS system.

4. The method of claim 2, wherein the reference map associated with the initial location includes a plurality of reference localization points.

5. The method of claim 1, further comprising normalizing the observed environment lidar sensor data.

6. The method of claim 5, wherein normalizing the observed environment lidar sensor data includes upscaling the observed environment lidar sensor data to match a spatial density of a reference map associated with an initial location of the mobile entity.

7. The method of claim 5, wherein normalizing the observed environment lidar sensor data includes downscaling the observed environment lidar sensor data to match a spatial density of a reference map associated with an initial location of the mobile entity.

8. The method of claim 5, wherein normalizing the observed environment lidar sensor data includes subsampling the observed environment lidar sensor data.

9. The method of claim 1, wherein transforming the observed environment lidar sensor data into the one or more alternative observed environment candidates includes shifting the observed environment lidar sensor data in at least one of six degrees of freedom.

10. The method of claim 1, wherein transforming the observed environment lidar sensor data into the one or more alternative observed environment candidates includes shifting the observed environment lidar sensor data in at least one of four degrees of freedom.

11. The method of claim 1, wherein calculating the corresponding observed environment reduced representation for the observed environment lidar sensor data and each of the one or more alternative observed environment candidates includes subdividing a corresponding 3-D region associated with the observed environment lidar sensor data and each of the one or more alternative observed environment candidates into a corresponding plurality of 3-D subregions.

12. The method of claim 11, wherein calculating the corresponding observed environment reduced representation for the observed environment lidar sensor data and each of the one or more alternative observed environment candidates includes generating a corresponding fingerprint for each of the corresponding plurality of 3-D subregions.

13. The method of claim 1, wherein correlating the observed environment reduced representations with reference reduced representations for different geographical locations includes comparing fingerprints associated with the observed environment reduced representations with fingerprints associated with the reference reduced representations.

14. The method of claim 1, further comprising determining whether a number of matches associated with the observed environment lidar sensor data and each of the one or more alternative observed environment candidates is above a match threshold.

15. The method of claim 14, wherein the current location of the mobile entity is identified in response to determining that the number of matches associated with the observed environment lidar sensor data or one of the one or more alternative observed environment candidates is above the match threshold.

16. A system, comprising:
a lidar sensor configured to detect observed environment lidar sensor data including a plurality of spatial points; and
a processor configured to:
transform the observed environment lidar sensor data into one or more alternative observed environment candidates;
calculate a corresponding observed environment reduced representation for the observed environment lidar sensor data and each of the one or more alternative observed environment candidates;
correlate the observed environment reduced representations with reference reduced representations for different geographical locations to determine correlation results; and
based on the correlation results, identifying a current location of the mobile entity.

17. The system of claim 16, wherein the processor is configured to receive a reference map associated with an initial location of the mobile entity.

18. The system of claim 16, wherein the processor is configured to normalize the observed environment lidar sensor data.

19. The system of claim 16, wherein to transform the observed environment lidar sensor data into the one or more alternative observed environment candidates, the processor is configured to shift the observed environment lidar sensor data in at least one of six degrees of freedom.

20. A computer program product embodied in a non-transitory computer readable medium and comprising computer instructions for:
receiving for a mobile entity, observed environment lidar sensor data including a plurality of spatial points;
transforming the observed environment lidar sensor data into one or more alternative observed environment candidates;
calculating a corresponding observed environment reduced representation for the observed environment lidar sensor data and each of the one or more alternative observed environment candidates;
correlating the observed environment reduced representations with reference reduced representations for different geographical locations to determine correlation results; and
based on the correlation results, identifying a current location of the mobile entity.
